(19) United States
(12) Patent Application Publication
(10) Pub. No.: US 2004/0266399 A1
(43) Pub. Date: Dec. 30, 2004

(54) METHOD AND APPARATUS FOR PROVIDING SELECTED STATUS ANNOUNCEMENTS FROM A WIRELESS TELEPHONE USER TO A CALLER

(76) Inventor: Anita Hogans Simpson, Decatur, GA (US)

Correspondence Address: CANTOR COLBURN LLP, 55 GRIFFIN ROAD SOUTH, BLOOMFIELD, CT, 06002, US

(21) Appl. No.: 10/611,383

(22) Filed: Jun. 30, 2003

(51) Int. Cl. G05F 1/40; G05F 1/44; G05F 1/56; G05F 1/618

(52) U.S. Cl. 455/412.1; 455/414.1

(57) ABSTRACT

A method for providing selected status announcements from a wireless telephone user to a caller comprising receiving an incoming call from a caller. The method further comprises that responsive to a determination that an automatic answering mode applies to the incoming call: receiving a pre-selected announcement action corresponding to the incoming telephone call and performing the pre-selected announcement action. If the pre-selected announcement action includes a hold announcement, then the incoming telephone call is answered by providing the caller with the hold announcement and placing the wireless telephone in mute mode until the user has taken the incoming telephone call. The method further comprises that responsive to a determination that a manual answering mode applies to the incoming call, receiving a user-selected announcement action. The user selected announcement action is selected by the user from a list of announcement actions and the user selected announcement action is selected in response to receiving the incoming telephone call. The user selected announcement action is performed, including answering the telephone call by providing the caller with a hold announcement and placing the wireless telephone in mute mode until the user has taken the incoming telephone call, if the user-selected announcement action includes the hold announcement. If the user selected announcement action includes a call-back announcement, then the caller is provided with the call-back announcement and the telephone call is disconnected.

### BACKGROUND OF THE INVENTION

The present disclosure relates generally to a method of providing selected status announcements from a wireless telephone user to a caller and in particular, to a method of providing a telephone answering and hold feature based on user selection.

Cellular telephones provide convenience and safety to users by giving the users the ability to make and receive telephone calls from any location where cellular service is available. The ability to receive telephone calls on a cellular telephone is limited to the times when the telephone is turned on. When the telephone is turned off, a caller will normally receive an announcement provided by the cellular service provider that the user is currently unavailable or is not within a service area. With some systems, a caller calling when a user's telephone is turned off will be able to leave a voice message for the user with the service provider. The user can then retrieve such a message by calling into the service provider.

While it is important for a user of a wireless telephone to be reachable for important telephone calls, there are times and locations where answering such an incoming telephone call is disruptive and inappropriate. One example of such a location is a meeting being attended by the user. While it may be necessary for the user to have their telephone turned on during the attendance of a meeting, having the telephone ring in the middle of the meeting can be very disruptive to the other participants. Typically, when receiving such a telephone call during a meeting the user will either answer the telephone call in the room, thereby disrupting the meeting with their talking, or will let the telephone ring until the user gets outside of the room and answers the telephone call, which is also very disruptive to the meeting and may result in the user missing the telephone call because the caller may hang up before the user answers. Thus, the user may be prevented from receiving a telephone call which may have been very important and a call for which the user desires to talk to the caller rather than allowing voice mail to pick up.

### BRIEF DESCRIPTION OF THE INVENTION

One aspect of the present invention is a method for providing selected status announcements from a wireless telephone user to a caller. The method comprises receiving an incoming call from a caller. The method further comprises that responsive to a determination that an automatic answering mode applies to the incoming call: receiving a pre-selected announcement action corresponding to the incoming telephone call and performing the pre-selected announcement action. If the pre-selected announcement action includes a hold announcement, then the incoming telephone call is answered by providing the caller with the hold announcement and placing the wireless telephone in mute mode until the user has taken the incoming telephone call. The method further comprises that responsive to a determination that a manual answering mode applies to the incoming call, receiving a user-selected announcement action. The user selected announcement action is selected by the user from a list of announcement actions and the user selected announcement action is selected in response to receiving the incoming telephone call. The user selected announcement action is performed, including answering the telephone call by providing the caller with a hold announcement and placing the wireless telephone in mute mode until the user has taken the incoming telephone call, if the user-selected announcement action includes the hold announcement. If the user selected announcement action includes a call-back announcement, then the caller is provided with the call-back announcement and the telephone call is disconnected.

In another aspect, a wireless telephone for providing selected status announcements from a wireless telephone user to a caller comprises a receiver for receiving incoming telephone calls and an automatic answering unit in communication with the receiver. The automatic answering unit includes instructions to implement a method comprising receiving an incoming call from a caller. The method further comprises that responsive to a determination that an automatic answering mode applies to the incoming call: receiving a pre-selected announcement action corresponding to the incoming telephone call and performing the pre-selected announcement action. If the pre-selected announcement action includes a hold announcement, then the incoming telephone call is answered by providing the caller with the hold announcement and placing the wireless telephone in mute mode until the user has taken the incoming telephone call. The method further comprises that responsive to a determination that a manual answering mode applies to the incoming call, receiving a user-selected announcement action. The user selected announcement action is selected by the user from a list of announcement actions and the user selected announcement action is selected in response to receiving the incoming telephone call. The user selected announcement action is performed, including answering the telephone call by providing the caller with a hold announcement and placing the wireless telephone in mute mode until the user has taken the incoming telephone call, if the user-selected announcement action includes the hold announcement. If the user selected announcement action includes a call-back announcement, then the caller is provided with the call-back announcement and the telephone call is disconnected.

In a further aspect, a system for providing selected status announcements from a wireless telephone user to a caller, the system comprising a network, a wireless telephone in communication with the network and a host system in communication with the network. The host system includes instructions to implement a method comprising receiving an incoming call from a caller. The method further comprises that responsive to a determination that an automatic answering mode applies to the incoming call: receiving a pre-selected announcement action corresponding to the incoming telephone call and performing the pre-selected announcement action. If the pre-selected announcement action includes a hold announcement, then the incoming telephone call is answered by providing the caller with the hold announcement and placing the wireless telephone in mute mode until the user has taken the incoming telephone call. The method further comprises that responsive to a determination that a manual answering mode applies to the incoming call, receiving a user-selected announcement action. The user selected announcement action is selected by the user from a list of announcement actions and the user selected announcement action is selected in response to receiving the incoming telephone call. The user selected announcement action is performed, including answering the telephone call by providing the caller with a hold announcement and placing the wireless telephone in mute mode until the user has taken the incoming telephone call, if the user-selected announcement action includes the hold announcement. If the user selected announcement action includes a call-back announcement, then the caller is provided with the call-back announcement and the telephone call is disconnected.

In a further aspect, a computer program product for providing selected status announcements from a wireless telephone user to a caller comprises a storage medium readable by a processing circuit and storing instructions for execution by the processing circuit for performing a method comprising receiving an incoming call from a caller. The method further comprises that responsive to a determination that an automatic answering mode applies to the incoming call: receiving a pre-selected announcement action corresponding to the incoming telephone call and performing the pre-selected announcement action. If the pre-selected announcement action includes a hold announcement, then the incoming telephone call is answered by providing the caller with the hold announcement and placing the wireless telephone in mute mode until the user has taken the incoming telephone call. The method further comprises that responsive to a determination that a manual answering mode applies to the incoming call, receiving a user-selected announcement action. The user selected announcement action is selected by the user from a list of announcement actions and the user selected announcement action is selected in response to receiving the incoming telephone call. The user selected announcement action is performed, including answering the telephone call by providing the caller with a hold announcement and placing the wireless telephone in mute mode until the user has taken the incoming telephone call, if the user-selected announcement action includes the hold announcement. If the user selected announcement action includes a call-back announcement, then the caller is provided with the call-back announcement and the telephone call is disconnected.

### BRIEF DESCRIPTION OF THE DRAWINGS

Referring to the exemplary drawings wherein like elements are numbered alike in the several FIGURES:

FIG. 1 is a pictorial diagram of a wireless telephone in accordance with an exemplary embodiment of the present invention;

FIG. 2 is a block diagram of a wireless telephone in accordance with an exemplary embodiment of the present invention;

FIG. 3 is a flow diagram of the process utilized by an exemplary embodiment of the present invention;

FIG. 4 is a flow diagram of an exemplary process for creating answer announcements;

FIG. 5 is a flow diagram of an exemplary process for creating a default announcement; and

FIG. 6 is a system diagram of an alternate exemplary embodiment of the present invention.

### DETAILED DESCRIPTION OF THE INVENTION

Wireless telephones are widely available and carried on the owner's person most of the time. In the business industry, the protocol is usually to place the telephone in “silent mode” during meetings and at other non-interruptible times. While this does prevent the telephone from sounding off at inopportune times, it does not solve the problem of how to answer the call in the midst of a meeting, without calling attention to one's self The very nature of having the telephone is to give the owner the convenience of accepting calls at any time. For example, when a person receives a call while in a meeting, the usual behavior is for the person to hurry out of the meeting room to try to catch the telephone call. Others try to answer very quietly, probably asking the caller to hold for a second. Either method is somewhat awkward.

An exemplary embodiment of the present invention allows the wireless telephone user to record personal announcements that are stored in the wireless telephone. When a call is received, the wireless telephone will display the Caller ID (if available) along with announcement options. The user may select an announcement option. For example, if the user cannot answer right away, but wants to speak to the caller, the user will select the option to have the wireless telephone answer on their behalf and play the selected personal announcement. After playing the announcement, the wireless telephone will not disconnect, but simply stay connected to the call as if the user had answered the call. Alternatively, the user may select a personalized announcement (e.g., “I am in a meeting right now but will call you after two p.m.”) to be sent to the caller based on the Caller ID and then disconnect. Another alternative is to send the caller into a voice mail system to play a specific voice mail announcement or a general announcement. The manner in which the telephone call is handled may be predetermined based on rules set up by the wireless customer (e.g., based on the time of day, the Caller ID) or the manner may be selected by the wireless customer in response to receiving a telephone call.

Additionally, an embodiment of the present invention may be used with the existing “auto-answer” capability found in many wireless telephones. When auto-answer is set, the telephone automatically answers incoming calls. It is up to the wireless customer to speak (e.g., “HELLO”) in order for the calling party to known that they are on the line. An embodiment of the present invention may allow auto-answer to be enhanced by answering the incoming call and immediately playing a pre-selected announcement to the calling party. In addition, an embodiment of the present invention allows the phone to flash its display to alert the wireless customer that a call is on the line.

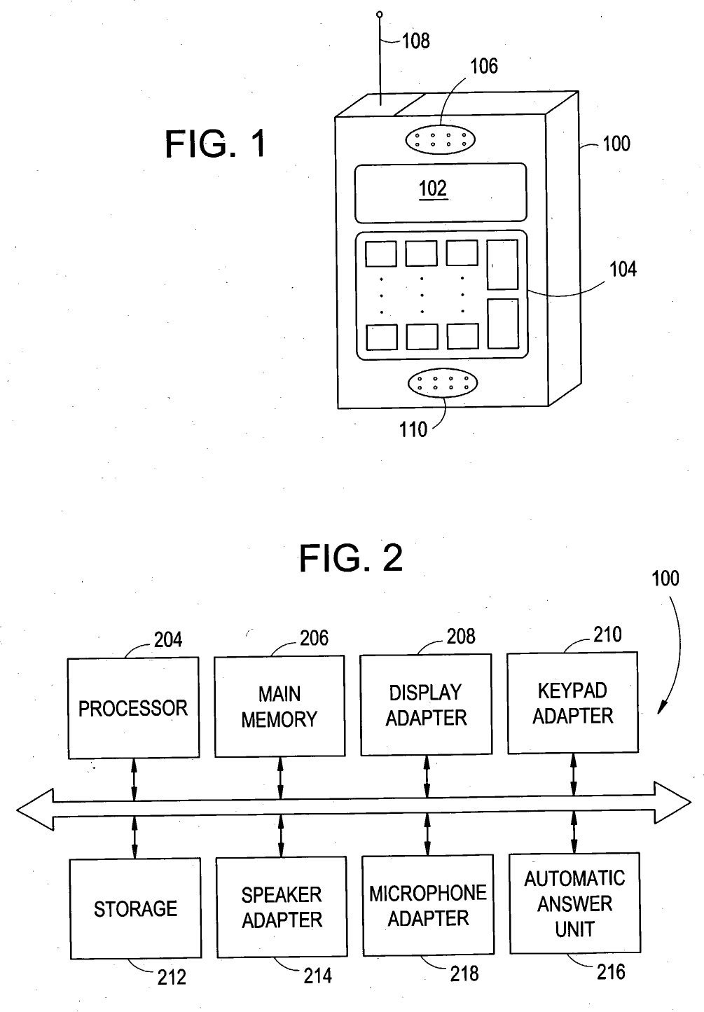

FIG. 1 is a pictorial diagram of a wireless telephone that may be utilized by an exemplary embodiment of the present invention. The wireless telephone 100 includes a display 102 for presenting textual and graphical information. The display 102 may be a known display device, such as a liquid crystal display (LCD) device. The display may be utilized to present a map or directions, photographs, video, calendar information, a telephone directory, an electronic mail announcement, or the telephone number of a dialed party. The wireless telephone 100 may also include a keypad 104, a speaker 106, an antenna 108 and a microphone 110. The keypad 104 may be utilized to receive user input and to scroll through announcement options. The speaker 106 provides a mechanism for audio output, such as the voice audio of a party to whom the user of the wireless telephone 100 may be speaking. The microphone 110 provides a mechanism for audio input (e.g., to speak to a called party). The antenna 108 provides a mechanism used in establishing a wireless communication link between the wireless telephone 100 and a wireless telephone network. The wireless telephone 100 depicted in FIG. 1 is an example one type of wireless telephone and any wireless telephone known in the art may be utilized with an exemplary embodiment of the present invention.

Referring to FIG. 2, a block diagram of an exemplary system included in the wireless telephone 100 is depicted. The wireless telephone 100 depicted in FIG. 2 is an example of a wireless telephone in which code or instructions implementing the processes of the present invention may be located. The wireless telephone 100 includes a bus 202 to which the processor 204 and the main memory 206 are connected. The display adapter 208, keypad adapter 210, storage 212, microphone adapter 218, audio adapter 214 and automatic answer unit 216 are also connected to the bus 202. In an exemplary embodiment of the present invention, the user announcements (e.g., hold, call-back and voice mail) are held in storage 212 along with automatic answering call flow information (e.g., default announcement, connection between incoming telephone number and action to be taken). The code to perform the functions associated with providing user selected status announcements is contained in the automatic answer unit 216, along with the code to provide the mechanism to answer the telephone when the user is busy without requiring the user to speak.

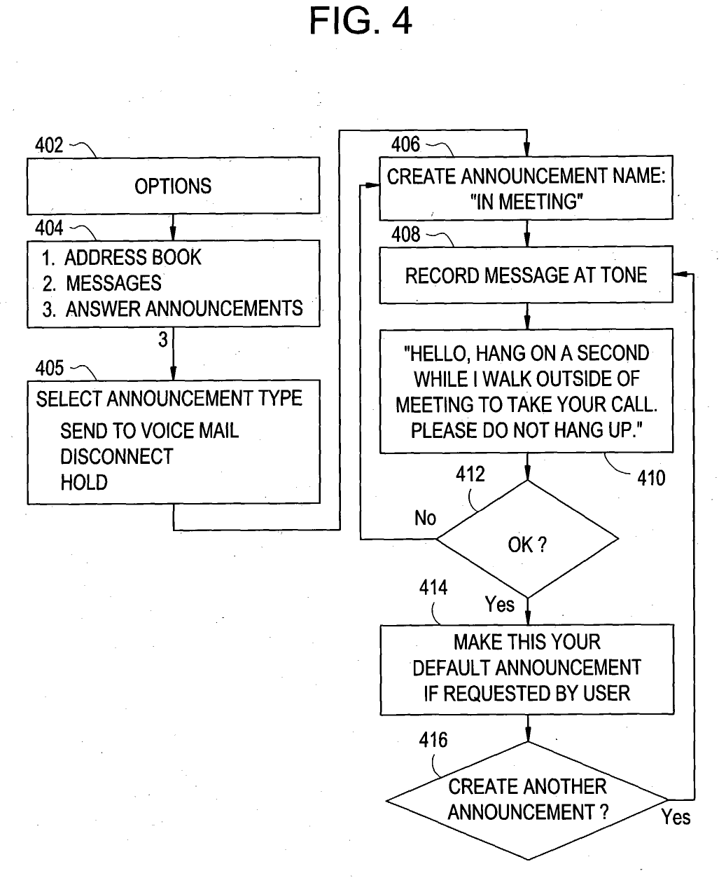

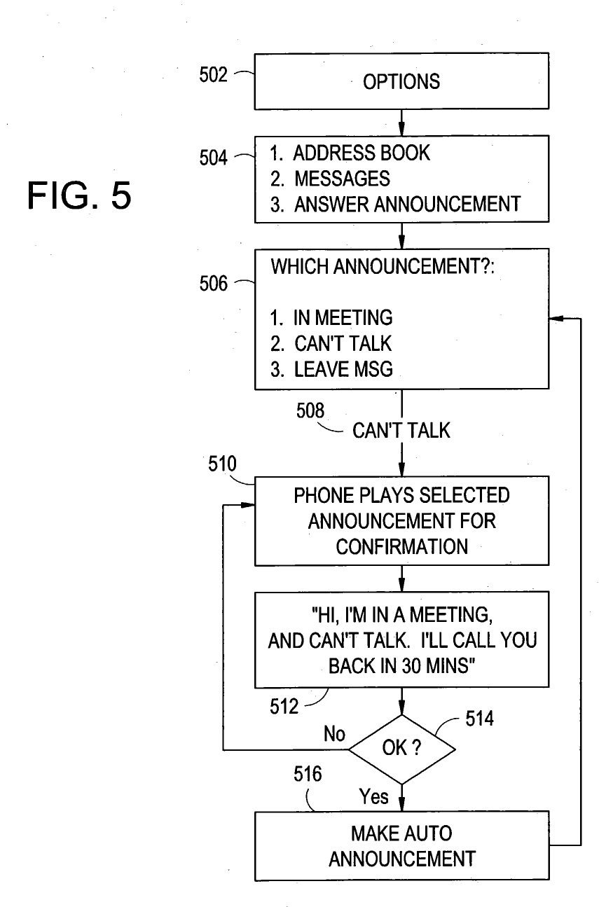

An exemplary embodiment of the present invention steps the user through recording up to “N” pre-recorded announcements, where “N” is determined based on the size of the storage 212 in the wireless telephone 100 and the amount of space allocated for storing announcements in storage 212. In addition, the telephone may also come with factory recorded standard announcements. The creation and updating of the pre-recorded announcements is described below in reference to FIGS. 4 and 5.

An exemplary embodiment of the present invention includes two answering modes: manual and automatic. For the manual announcement mode, when an incoming call is received, the telephone will display the Caller ID and announcement options via the display 102. The user then selects the personal announcement, stored in storage 212, to be played to the caller. The available announcements are listed on the display 102 and the user may scroll down through them and select one. The user may specify that the list be sorted based on frequency of the use of the announcements. Once the user selects an announcement, the wireless telephone 100 then plays the selected announcement to the caller. If the selected announcement is a “hold announcement” then the wireless telephone 100 does not disconnect, but stays connected to the caller, as if the user had answered the call. Alternatively, if the user has selected the automatic answering mode, the Caller ID is displayed and the wireless telephone plays-the announcement that was pre-selected for automatic answering (e.g., based on incoming Caller ID), time of day, default for no matches). Again, if the selected announcement is a “hold announcement” then the wireless telephone 100 does not disconnect, but stays connected to the caller, as if the user had answered the call.

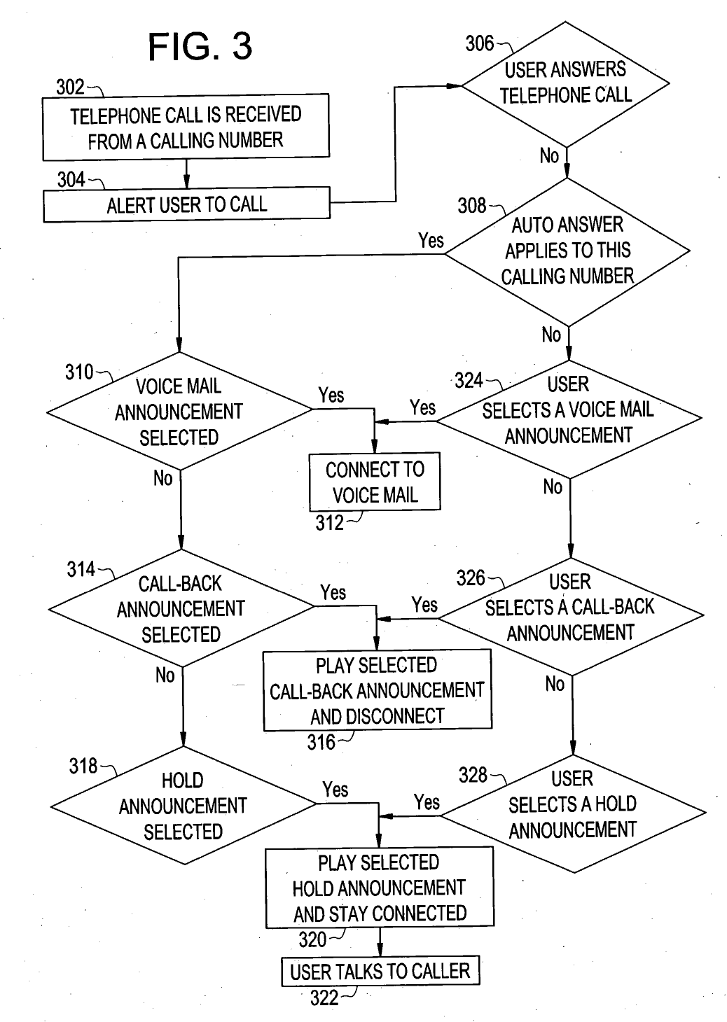

FIG. 3 is a flow diagram of the process utilized by an exemplary embodiment of the present invention to respond to telephone calls in a manual answering mode and in an automatic answering mode. At step 302, a telephone call is received from a calling number. The calling number, or Caller ID, if available, is displayed in the display 102 area of the wireless telephone 100. The user is alerted to the call at step 304 by methods known the art including a ring tone, a flashing light and vibration. At step 306, the user may choose to answer the telephone call in the standard manner. If the user answers the telephone call, then processing is complete. If the user does not answer the telephone call, then step 308 is performed to determine if the automatic answer mode applies to this telephone call. This determination may be made based on logic included in the automatic answer unit 220, data included in storage 212, data included in main memory 206 and the Caller ID of the incoming telephone call. For example, the user may have set up the answering options so that at particular dates and times the automatic answer mode applies to particular Caller IDs. Alternatively, the user may have set up the answering options so that particular Caller IDs are sent to voicemail without first alerting the user of the incoming call, or the user may specify a particular voice mail announcement to be played to a particular user. Any number of combinations are possible based on the available data.

If, at step 308, it is determined that the automatic answer mode applies, then step 310 is performed to determine if the automatic answer specified by the user is to send the caller to a voice mail system. The voice mail system may be located in a wireless network or a public switched telephone network (PSTN) network. If the automatic answer mode specifies that the voice mail option applies to the incoming telephone call, then step 312 is performed to connect the caller to voice mail. The caller may then receive a specific voice mail announcement pre-selected by the user for the caller or the caller may receive a generic voice mail announcement. If, at step 310, it is determined that the voice mail announcement does not apply, then step 314 is performed to determine if the call-back announcement option was pre-selected by the user for answering the incoming telephone call (e.g., based on time of day, Caller ID). If the call-back announcement option applies, then step 316 is performed to play the pre-selected call-back option. The particular call-back announcement may be pre-selected by the user based on the Caller ID and/or other criteria. Example call-back announcements may include: “I am currently in a meeting and will call you back after three” and “Jim, I am currently in a meeting and will call you back after three to discuss the contract terms.”

If, at step 314, it is determined that the voice mail announcement does not apply, then step 318 is performed to determine if the hold-announcement option applies to the incoming telephone call (e.g., based on time of day, Caller ID). If the hold-announcement option applies, then step 320 is performed. At step 320, the automatic answer unit 220 sends the user pre-selected, prerecorded announcement to the caller indicating that the user will pick up phone and speak to the caller momentarily and requesting that the caller not hang up. In an exemplary embodiment of the present invention, as the announcement is sent, the telephone is also placed in mute mode such that no sounds on the user's end are picked up and transmitted to the caller until the user is ready to take the call. The prerecorded announcement may be a recording made by the user or it may be created using a voice-generating engine known in the art to create the announcement. Several announcements may be available on the wireless telephone 100 and the user may select a particular announcement in advance, based on the circumstances or the automatic answer unit 220 may select an announcement based, for example, on the time of day or the identity of the caller (e.g., the Caller ID). At step 322, the user talks to the caller in person via the wireless telephone 100.

The manual answering mode process is begins at step 324, if it was determined at step 308 that the automatic answering mode doesn't apply to the incoming telephone call. The manual answering mode process is similar to the automatic answering mode except that the user selects the answering option (e.g., voice mail, call-back announcement, hold announcement) in response to receiving the telephone call and viewing the Caller ID, if available. In addition, the user may select a specific pre-recorded announcement to be sent from the list of available voice mail, call-back and hold announcements. The user may scroll through the available announcements via the wireless telephone 100 display 102.

At step 324, it is determined if the user has selected a voice mail announcement. If the user has selected a voice mail announcement, then the telephone call is connected to the voice mail system and either the selected voice mail announcement, or a default voice mail announcement (e.g., based on Caller ID, date) if a specific one was not selected, is communicated to the caller. If the user did not select a voice mail announcement, then step 326 is performed to determine if the user has selected a call-back announcement. If the user has selected a call-back announcement, then step 316 is performed. Again, if a specific call-back announcement was selected by the user, then it is communicated to the caller, otherwise a default call-back announcement is communicated to the user. If the user did not select a call-back announcement, then step 328 is performed to determine if the user selected a hold announcement. If a hold announcement was selected, then step 320 is performed. Again, a specific hold announcement, if one is selected by the user, is played for the caller; otherwise a default hold announcement is communicated to the user. At step 322, the user talks to the caller via the wireless telephone 100. FIG. 3 depicts one embodiment of a call flow for providing selected status announcements from a wireless telephone user to a caller. Additional call flows may be supported by an alternate exemplary embodiment of the present invention. For example, the order of steps 310, 314 and 318 may be changed (e.g., step 310 and 314 reversed) as well as the order of steps 324, 326 and 328.

FIG. 4 is a flow diagram of an exemplary process for creating announcements to be utilized by an exemplary embodiment of the present invention. This process may be implemented by code included in the automatic answer unit 220 located on the wireless telephone 100 and the announcements stored in storage 212. At step 402, the user selects the options menu and the options listed at step 404 are displayed via the display 102 on the wireless telephone 100. In this example, the user selects option “3” Answer Announcements” and “create a new announcement.” At step 405, the user selects from three types of messages: voice mail, disconnect (call back) and hold. The user may have more than one message associated with each message type. At step 406, the user creates a new hold announcement named “In Meeting” and at step 408 records a message associated with the “In Meeting”announcement. In this example, the “In Meeting” announcement is recorded as shown at 410: “Hello. Hang on a second while I walk outside of the meeting to take your call. Please do not hang up.” At step 412, the user verifies that the announcement is okay and at step 414 is given the choice of making the new announcement the default announcement. The announcement is stored in the storage 212 on the wireless telephone 100. Next, at step 416, the user is given the option of creating another announcement. If the user selects the option to create another announcement, then processing continues at step 406. Otherwise, the creating announcements process is complete. In this manner, the user may create a list of tailored announcements that cover user specific situations and the user may name them so that they are easy for the user to remember.

FIG. 5 is a flow diagram of an exemplary process for creating a default announcement to be utilized by an exemplary embodiment of the present invention. This process may be implemented by code included in the automatic answer unit 220 located on the wireless telephone 100. At step 502, the user selects the options menu and the options listed at step 504 are displayed via the display 102 on the wireless telephone 100. In this example, the user selects option “3” Answer Announcements”and “change default announcement.” At step 506, the user selects a new default announcement (e.g., for use in automatic answer mode, as a default call-back message) from the list of available pre-recorded announcements. In the example depicted in FIG. 5, the user selects “Can't Talk” at 508 and at step 510, the wireless telephone 100 plays the selected announcement for confirmation. As shown in box 512, the selected message is “Hi, I'm in a meeting and can't talk. I'll call you back in 30 minutes.” At step 514, the user confirms that the played announcement should be the default and then at step 516 specifies if it should also be the default announcement for automatic answer mode. The user may specify that the played message should be the default in response to receiving a telephone call from a particular Caller ID and/or at a particular time of day.

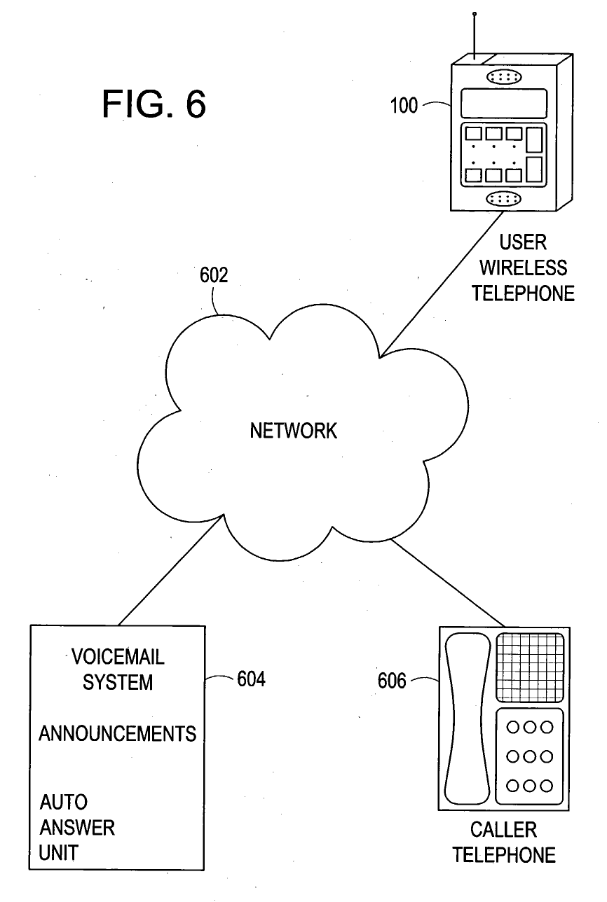

FIG. 6 is a system diagram of an alternate exemplary embodiment of the present invention. The alternate exemplary embodiment includes having the announcements and the auto answer unit logic located on a system 604 with access to a network 602 for communication with the wireless telephone 100. In addition, the caller telephone 606 is in communication with the network 602. The network may be any network known in the art for communicating voice messages, such as a public switched telephone network or a internet protocol network. The alternate exemplary embodiment depicted in FIG. 6 requires interaction between the network 602 and the wireless telephone 100 to set-up and provide selected status announcements from a wireless telephone user to a caller. Network elements such as an intelligent peripheral or a voicemail system may be utilized to store the user announcements. The system 604 for providing selected status announcements from a wireless telephone user to a caller, as depicted in FIG. 6, is set up by having the network-based auto answer unit application stepping the user through recording announcements. In addition, the auto answer unit application may include factory recorded standard messages.

For the network based application depicted in FIG. 6, the manual answering mode includes displaying the Caller ID and answering options (e.g., hold, call-back and voice mail) on the wireless telephone 100 when the incoming call is received. However, the caller and incoming call will continue to be held at the network element level. The user then selects a personal announcement to be played to the caller. The available announcements are listed for the user to scroll through and select, where the list order may be determined based on frequency of use of the announcements. When the user selects an option, a signal is sent back to the auto answer unit application running on the network system 604, instructing it to play the selected announcement to the caller. After playing the message, if the user selects a hold announcement option, the network 602 connects the caller with the wireless telephone 100. The text message will then re-display the Caller ID and also provide a symbol that denotes that the personal announcement has been played and that the wireless telephone 100 has answered the telephone call and that the caller is waiting.

An exemplary embodiment of the present invention allows a user to select a pre-recorded message to play when the user's wireless telephone is in automatic answer or manual answer mode. It allows the user to select, in real time, a personal message to be played to the caller. In addition, an exemplary embodiment of the present invention allows the wireless telephone to remain connected to the caller after playing a hold message. This may allow the user to have some extra time to find a quiet place to speak to the caller without being rude and lowers the chance that the caller will hang up before the user answers the wireless telephone.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, an embodiment of the present invention may include telephones other than wireless telephones. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for providing selected status announcements from a wireless telephone user to a caller, said method comprising:
receiving an incoming telephone call from a caller;
responsive to a determination that an automatic answering mode applies to the incoming call:
receiving a pre-selected announcement action corresponding to said incoming telephone call; and
performing said pre-selected announcement action wherein if said pre-selected announcement action includes a hold announcement then answering said incoming telephone call by providing the caller with the hold announcement; and
responsive to a determination that a manual answering mode applies to the incoming call:
receiving a user-selected announcement action selected by said user from a list of announcement actions, said user-selected announcement action selected in response to receiving said incoming telephone call; and
performing said user-selected announcement action including:
if said user-selected announcement action includes said hold announcement then answering said incoming telephone call by providing the caller with the hold announcement; and
if said user-selected announcement action includes a call-back announcement, then providing the caller with the call-back announcement and disconnecting the telephone call.

2. The method of claim 1 wherein said answering said incoming telephone call by providing the caller with the hold announcement further includes placing the wireless telephone in mute mode until the user has taken the incoming telephone call.

3. The method of claim 1 further comprising notifying said user of said incoming telephone call.

4. The method of claim 3 wherein said notifying includes one or more of an audible noise, a vibration, and a light.

5. The method of claim 1 further comprising reminding said user that said caller is on hold in response to said providing the caller with the hold announcement.

6. The method of claim 5 wherein said reminding said user that said caller is on hold includes one or more of an audible noise, a vibration, and a light.

7. The method of claim 1 wherein input to said determination that an automatic answering mode applies to the incoming call includes a Caller ID associated with said caller.

8. The method of claim 1 wherein input to said determination that an automatic answering mode applies to the incoming call includes a time of day associated with said telephone call.

9. The method of claim 1 wherein input to said determination that an automatic answering mode applies to the incoming call includes an instruction from said user.

10. The method of claim 1 wherein input to said determination that a manual mode applies to the incoming call includes one or more of a Caller ID associated with said caller, a time of day associated with said telephone call and an instruction from said user.

11. The method of claim 1 wherein said pre-selected announcement action includes a hold announcement.

12. The method of claim 1 wherein said pre-selected announcement action includes a call-back announcement.

13. The method of claim 1 wherein said pre-selected announcement action includes a voice mail announcement.

14. The method of claim 13 wherein said performing said pre-selected announcement action includes providing said caller with a recorded announcement and directing said call to a voice mail system.

15. The method of claim 1 wherein said pre-selected announcement action is created by said user.

16. The method of claim 1 wherein said hold announcement includes an indication that said user will take said call momentarily.

17. The method of claim 1 wherein said hold announcement is pre-selected from a plurality of said hold announcements.

18. The method of claim 1 wherein said call-back announcement is selected from a plurality of said call-back announcements.

19. The method of claim 1 wherein said performing said user-selected announcement action further includes if said user-selected announcement action includes a voice mail announcement, then directing said call to a voice mail system including specifying said voice mail announcement.

20. The method of claim 1 wherein said performing said user-selected announcement action further includes if said user-selected announcement action includes a voice mail announcement, then providing said caller with a recorded announcement and directing said call to a voice mail system.

21. A wireless telephone for providing selected status announcements from a wireless telephone user to a caller, the system comprising:
a receiver which receives an incoming telephone call;
an automatic answering unit in communication with said receiver and including instructions to implement a method comprising:
receiving an incoming telephone call from a caller;
responsive to a determination that an automatic answering mode applies to the incoming call:
receiving a pre-selected announcement action corresponding to said incoming telephone call; and
performing said pre-selected announcement action wherein if said pre-selected announcement action includes a hold announcement then answering said incoming telephone call by providing the caller with the hold announcement; and
responsive to a determination that a manual answering mode applies to the incoming call:
receiving a user-selected announcement action selected by said user from a list of announcement actions, said user-selected announcement action selected in response to receiving said incoming telephone call; and
performing said user-selected announcement action including:
if said user-selected announcement action includes said hold announcement then answering said incoming telephone call by providing the caller with the hold announcement; and
if said user-selected announcement action includes a call back announcement, then providing the caller with the call-back announcement and disconnecting the telephone call.

22. A system for providing selected status announcements from a wireless telephone user to a caller, the system comprising:
a network;
a wireless telephone in communication with said network; and
a host system in communication with said network, wherein said host system includes instructions to implement method comprising:
receiving an incoming telephone call from a caller to the wireless telephone;
responsive to a determination that an automatic answering mode applies to the incoming call:
receiving a pre-selected announcement action corresponding to said incoming telephone call; and
performing said pre-selected announcement action wherein if said pre-selected announcement action includes a hold announcement then answering said incoming telephone call by providing the caller with the hold announcement; and
responsive to a determination that a manual answering mode applies to the incoming call:
receiving a user-selected announcement action from said wireless telephone via said network, said user-selected announcement action selected by said user from a list of announcement actions, said user-selected announcement action selected in response to receiving said incoming telephone call; and
performing said user-selected announcement action including:
if said user-selected announcement action includes said hold announcement then answering said incoming telephone call by providing the caller with the hold announcement;
if said user-selected announcement action includes a voice mail announcement then directing said call to a voicemail system; and
if said user-selected announcement action includes a call back announcement, then providing the caller with the call-back announcement and disconnecting the telephone call.

23. The system of claim 22 wherein said performing said pre-selected announcement action further includes if said user-selected announcement action includes a voice mail announcement, then directing said call to a voice mail system.

24. The system of claim 22 wherein said network is a public switched telephone network.

25. The system of claim 22 wherein said network is an internet protocol network.

26. A computer program product for providing selected status announcements from a wireless telephone user to a caller, the computer program product comprising:
a storage medium readable by a processing circuit and storing instructions for execution by the processing circuit for performing a method comprising:
receiving an incoming telephone call from a caller;
responsive to a determination that an automatic answering mode applies to the incoming call:
receiving a pre-selected announcement action corresponding to said incoming telephone call; and
performing said pre-selected announcement action wherein if said pre-selected announcement action includes a hold announcement then answering said incoming telephone call by providing the caller with the hold announcement; and
responsive to a determination that a manual answering mode applies to the incoming call:
receiving a user-selected announcement action selected by said user from a list of announcement actions, said user-selected announcement action selected in response to receiving said incoming telephone call; and
performing said user-selected announcement action including:
if said user-selected announcement action includes said hold announcement then answering said incoming telephone call by providing the caller with the hold announcement; and
if said user-selected announcement action includes a call back announcement, then providing the caller with the call-back announcement and disconnecting the telephone call.
